(19) United States
(12) Patent Application Publication
(10) Pub. No.: US 2010/0162898 A1
(43) Pub. Date: Jul. 1, 2010

(54) BREWING UNIT OF A DEVICE FOR PREPARING BEVERAGES

(75) Inventor: Gotthard Mahlich, Kronberg (DE)

Correspondence Address: Quinn Emanuel Urquhart & Sullivan, LLP, 865 S. FIGUEROA STREET, 10TH FLOOR, LOS ANGELES, CA, 90017, US

(73) Assignee: Eugster/Frismag AG

(21) Appl. No.: 12/452,250

(22) PCT Filed: Jun. 12, 2008
(86) PCT No.: PCT/EP2008/004712

§ 371 Date: Mar. 8, 2010

(30) Foreign Application Priority Data
Jun. 21, 2007 (DE) 20 2007 008 814.0

(51) Int. Cl. A47J 31/44

(52) U.S. Cl. 99/290

(57) ABSTRACT

The invention relates to a brewing unit of a device for preparing beverages, comprising a first receiving device which is a coffee brewing chamber (9) having an outlet, suitable for receiving loose coffee powder or a coffee or cocoa portion unit (10) and suitable for the preparation of a beverage by using said unit. For a more economical preparation process, the brewing unit is enhanced such that the brewing unit is provided with a second receiving device, comprising a docking device (7) for receiving a removable encapsulated multi-portion container (41) for milk powder.

The present invention relates to a brewing unit of a device for preparing beverages which comprises a brewing chamber for receiving ground loose coffee powder or for receiving a pre-portioned coffee or cocoa portion unit and is suited for the preparation of a beverage by the use of it and which includes an outlet for the beverage liquid.

The prior art includes devices for preparing beverages including a brewing unit which is provided for using ground loose coffee powder or pre-portioned coffee or cocoa portion units or milk concentrate or milk powder units. Such portion units may be available in the form of aluminum or plastic capsules or in the form of pouches, and the contents of each is designed for the preparation of a normal amount of a beverage such as for instance a cup of coffee or of a coffee-milk beverage.

Brewing units of this kind for the use of loose coffee powder or for using pre-portioned portion units including powdery beverage base ingredients for preparing beverages constitute the state of the art and need not be described in detail.

Likewise, the use of milk powder or milk concentrate instead of fresh milk for preparing milk froth for cappuccino, i.e. a combination of coffee and milk froth on it, has been known. In household preparation devices, milk powder or milk concentrate capsules are preferably used for this purpose.

In commercial preparation devices, particularly in so-called vending machines, in contrast thereto, the milk powder is stocked in refillable containers solidly integrated in the preparation device, from which it is transported, portion-wise, i.e. for one cup each of the beverage to be prepared, by means of worm conveyors, into a mixing and frothing device, where it is mixed with water and frothed up by means of a rotating frothing stirrer.

In Patent Application No. DE 20 2006 008 409.6, a frothing device working with milk powder has been described which accesses, program-controlled, one milk powder portion each from a milk powder container integrated in a preparation device and produces milk froth by adding preparation water and air. This solution differs from the froth makers using a stirrer which are used in the vending machines insofar as the proper frothing up occurs by rotational vortexing of milk and air rather than by means of a mechanical stirrer.

This kind of the portion-wise milk powder addition from a storage container has the advantage that it is not necessary to insert, for each cappuccino preparation, a new portion unit into the preparation device; the disadvantage, however, is that not each commercially available milk powder is suited for milk froth generation, that unsuited milk powder might be filled into the storage container and no milk froth of satisfying consistence will be obtained. In contrast to the portion-wise addition of milk powder from a storage container, household coffee maker in particular make use of milk powder portion capsules, as mentioned already, in which only one milk powder portion each for one cup of cappuccino is contained. The portion units may be in the form of aluminum or plastics capsules and contain milk concentrate or milk powder that can be frothed up. In case of these portion capsules, the supply of the preparation water is realized by means of a water-conducting piercing needle which is pierced into the capsules. The water is in this case pumped, by means of a pump, from a water container and through a continuous-flow heater and via a hot water pipe to the piercing needles. Subsequently, the milk powder is dissolved in the capsule and is frothed up by means of a frothing device disposed in the capsule or, in case of capsules without an integrated frothing device, the milk obtained by dissolving is frothed up in a separate frothing device by the addition of air. This kind of milk froth preparation by means of portion capsules is used in coffee makers which for coffee preparation make use of pre-portioned coffee capsules, too.

The disadvantage of the use of one-portion milk powder capsules is that for each cappuccino preparation a new capsule has to be inserted and removed and that, in these devices for preparing beverages which process capsules having different contents, i.e. capsules for coffee, cocoa, milk concentrate or milk powder, only one housing chamber for the various capsules is available. In such devices for preparing beverages, it is, therefore, unavoidably necessary that in view of the utilization of the same housing chamber for coffee, cocoa and milk concentrate or milk powder capsules each second kind of preparation has to be performed in a second operational step. That means that for instance for a cappuccino preparation after the milk froth preparation cycle, first the used milk concentrate or milk powder capsule has to be removed from the brewing unit, subsequently the coffee capsule has to be inserted into the brewing unit and finally removed after the coffee preparation cycle. In this case, in addition, all capsules have the same water supply and beverage outlet means.

Determined by the system, this kind of preparation of a coffee milk beverage is un-economical since for each portion of a coffee milk beverage two one-portion capsules are required and in view of the successively performed loading and removing processes is elaborate and time consuming.

A disadvantage of the stationary refillable milk powder containers is that non-frothable milk powder may be filled in as well and no milk froth of satisfactory consistence will be obtained.

Hence, it is an object of the present invention to provide a brewing unit for a device for preparing beverages by means of which the preparation of beverages, particularly a coffee or cocoa preparation and the milk or milk froth generation, may be carried out by a more efficient preparation procedure in which retardations be filling and removing processes are either shortened or completely avoided.

To this purpose, a device for preparing beverages having the features of claim 1 is suggested.

The solution of the above problem provides that the brewing unit of the preparation device is equipped with a first receiving device in the form of a brewing chamber for receiving loose coffee powder or a coffee or cocoa portion unit and with a second receiving device in the form of a docking device provided for receiving an encapsulated exchangeable multi-portion milk powder container and to which a mixing or frothing device is associated which is suited for preparing milk or milk froth and which includes one outlet for the milk or the milk froth prepared.

By means of this brewing unit, both the coffee or cocoa preparation, on one hand, and the milk or milk froth generation, on the other, may proceed simultaneously or timely staggered, depending or the setting or control of the brewing unit, while filling of the brewing unit with a one-portion milk powder capsule is not necessary for each and every milk beverage preparation.

According to the invention, the brewing unit is equipped, as already mentioned, in addition to a brewing chamber for receiving loose coffee powder or receiving a coffee portion capsule or a coffee pouch, with a receiving device in the form of a docking unit for receiving an encapsulated multi-portion milk powder container. This multi-portion milk powder container combines the advantage of the stationary large storage container so that it is not necessary to insert a new capsule for each cappuccino preparation, with the advantage of the one-portion capsule that positively only frothable milk powder is used, and that it contains milk powder for a plurality of milk froth preparations and may be introduced into the preparation device as a removable part. Only the encapsulated and sealed capsule will warrant that only optimum frothable milk powder grades are used.

This kind of milk powder storage by means of a multi-portion milk powder container can be used in all coffee preparation devices independently from whether they are full automats equipped with coffee grinders or devices operating by means of brewing pistons for loose coffee powder or by means of coffee portion capsules or coffee pouches, provided they are equipped with a respective docking device for a multi-portion milk powder container according to the invention and a mixing and frothing device. The conditioning and the frothing of milk powder may be performed both by mechanical stirring and by means of the rotation vortexing method.

Such a brewing unit may be used in various ways; in order to solely prepare coffee, for instance, the coffee brewing chamber need be filled only with the loose coffee powder or with a coffee portion unit; or in order to prepare solely milk or milk froth, only one multi-portion milk powder container need be docked for a plurality of preparations; or for preparing a cappuccino or latte macchiato, both the coffee brewing chamber should be filled with either coffee or a coffee portion unit, and for several preparations, only one multi-portion milk powder container need be docked. According to claims 16 and 17, the brewing chamber and the docking device are usefully provided with checking means which check, in each case, the presence of a coffee portion unit or of a multi-portion milk powder container, and will open, according to claims 12 through 15, by means of a control arrangement, the preparation water supply, by means of a motor-operated ceramics disc valve or by means of solenoid or hose valve disposed in the preparation water supply pipes, only if and when the respective positions have been taken. In this way, a safe function of the brewing unit in case of alternate or simultaneous use of the brewing chamber and/or the docking device is guaranteed.

An essential aspect of the brewing unit consists in that it may preferably be used for the preparation of a coffee-milk beverage of milk and milk froth. To this purpose, it is necessary that the milk powder taken from the multi-portion milk powder container may be mixed in a mixing and frothing device and, depending on the kind of beverage desired, be frothed up. For this operation, to the docking device for the multi-portion milk powder container is associated, according to claim 3, a mixing and frothing device which is disposed below the docking device and is connected to its milk powder outlet. Nonetheless it is possible, according to claims 5 and 6, to design the frothing device removable for cleaning purposes or to realize it as an exchangeable throw-away part in order to assure a hygienic operation without time-consuming rinsing and cleaning processes. Structurally, both the coffee brewing chamber and the docking unit together with the mixing and frothing device may be designed compactly as a common structural unit. It is, however, also possible to design the coffee brewing unit and the docking unit including the mixing and the frothing device as separate units.

Irrespective of whether the two devices are arranged integrated in a common structural element or separated from each other, the outlets of the two devices are usefully so arranged that they can conduct the produce prepared in them either into one single receiving vessel or into two receiving vessels arranged one next to the other. Instead, however, it is possible in both cases of arrangement of the brewing chamber and the mixing and frothing device integrated in one structural unit or non-integrated, to join, according to claim 7, their outlets together to one common outlet channel in order to pass through it one homogenous beverage produce or, timely one after the other, two beverage produces into the receiving vessel.

It is also possible to provide, according to claim 22, the brewing unit additionally with a steam outlet nozzle for the generation of milk froth from fresh milk.

Moreover, for hygienic cleaning of the brewing chamber and of the mixing and frothing device, the brewing unit may be provided, according to claim 10, with a rinsing device which is to be activated simultaneously for the two devices wherein rinsing may be performed either before or after a beverage preparation cycle.

For flexible preparation of a variety of beverages and for milk conditioning, particularly the preparation of milk froth, a pump conveys water from a water storage tank through a continuous-flow water heater and, by interposing of a valve arrangement and a flow meter, into the coffee brewing chamber and/or the mixing and frothing device.

The valve arrangement may be activated by a control arrangement, according to claim 19, so that water is either supplied to the brewing chamber and to the mixing and frothing device substantially simultaneously or is supplied to the two preparation devices timely staggered, or only to the brewing chamber or only to the mixing and frothing device. By means of the control arrangement, therefore, the activation of only one or of both preparation devices, the preparation sequence, and the amounts of water respectively to be dosed is controlled. Particularly for a coffee-milk beverage, the following possibilities will thereby result: Simultaneous preparation of coffee and milk or milk froth, or first brewing of coffee and subsequently preparation of milk froth, or first preparation of milk froth and subsequently brewing of coffee, or first preparation of milk, subsequently of milk froth and finally of espresso. Besides, the amount of water supplied and the amount of the beverage resulting thereof may be selected.

The water supply into the brewing chamber and/or into the mixing and frothing device is effected, according to claim 12, as already described, by means of a valve arrangement which is preferably controlled by outputs of the control arrangement and is disposed between the continuous-flow water heater and the brewing chamber or the mixing and frothing device. According to claim 13, the controlled valve arrangement may be realized as a ceramics disc valve which is particularly suited for the preparation of high-quality drinks. According to claim 14, however, the controlled valves may be realized also as individual solenoid valves or, according to claim 15, as hose clip valves.

Preparation water amount control may be performed by means of the valves referred to and controlled, according to claim 19, by flow meters provided in the supply pipes and by the control arrangement or, according to claim 21, manually to conform with the subjective taste.

As mentioned above, checking units on the coffee brewing chamber according to claim 17, or on the second receiving device in combination with the control arrangement according to claim 16, may open a waters supply via the controlled valves to one of the preparation devices, or to both of them, only if and when one portion unit or a multi-portion milk powder container, respectively, has been placed in the receiving device.

To increase the operating reliability, it is advisable, according to claim 18, to provide furthermore checking means for a water supply stop in case of an opened brewing chamber in combination with the control arrangement and the controlled valves.

The preparation of a desired beverage may be realized fixed-programmed automatically in that the sequence of the preparation of the beverage components and the amounts thereof, particularly for the coffee and milk froth production, is fixed-programmed. A plurality of such programs for a variety of drinks may, according to claim 20, advantageously be stored in the control arrangement and may be selected by means of a selection means.

For the structural shape of the multi-portion milk powder container as suggested for use, a variety of versions is possible. It is common to the preferred embodiments that the multi-portion milk powder container is shown in the form of a cylindrical cartridge which, at its upper end, is solidly closed by a cover and at its lower end is narrowed downwardly, funnel-like, in the direction of the milk powder outlet and passes over into a neck which includes both the lower locking arrangements of the multi-portion milk powder container and, preferably also the docking and locking elements for the interaction with the docking elements of the device for preparing beverages.

It is also conceivable to provide a multi-portion milk powder container in which, for instance, a foil closes the non-narrowed cylinder bottom of the multi-portion milk powder container which is also equipped with the docking elements, and that the opening elements for the multi-portion milk powder container and the discharge funnel for the supply of the milk powder to the conveyor unit that conveys the milk powder to the mixing and frothing device constitute part of the preparation device.

Embodiments of the invention will be described in more detail in the following based on a drawing including 29 figures from which further advantageous features of the invention can be derived.

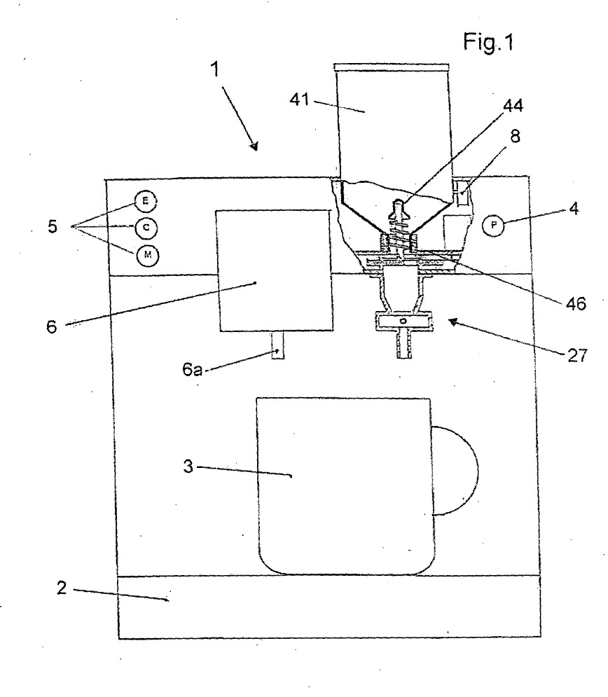

FIG. 1 is a diagrammatically represented device for preparing beverages, partly in cross section, comprising a coffee brewing unit for loose coffee powder and a docking device for a multi-portion container including a docked-on multi-portion container, partly in cross section, a presence checking means for the multi-portion container, a vertical ejection shaft for the locking cap of the multi-portion container including a worm conveyor and a mixing and frothing device.

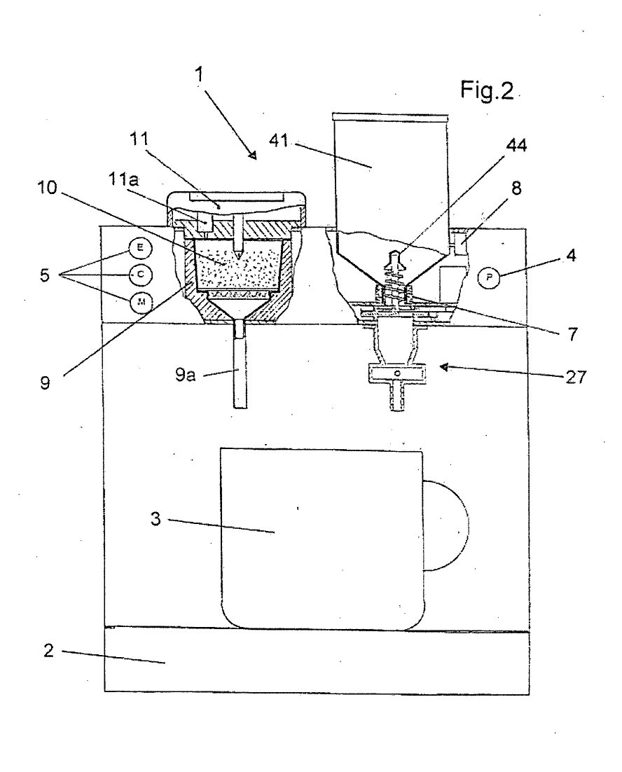

FIG. 2 is a diagrammatically represented device for preparing beverages, partly in cross section, comprising a brewing unit for a pre-portioned coffee capsule including an inserted coffee capsule, a docked-on multi-portion container, partly in cross section, a presence checking means for the multi-portion container, a vertical ejection shaft for the locking cap of the multi-portion container including a worm conveyor and a mixing and frothing device.

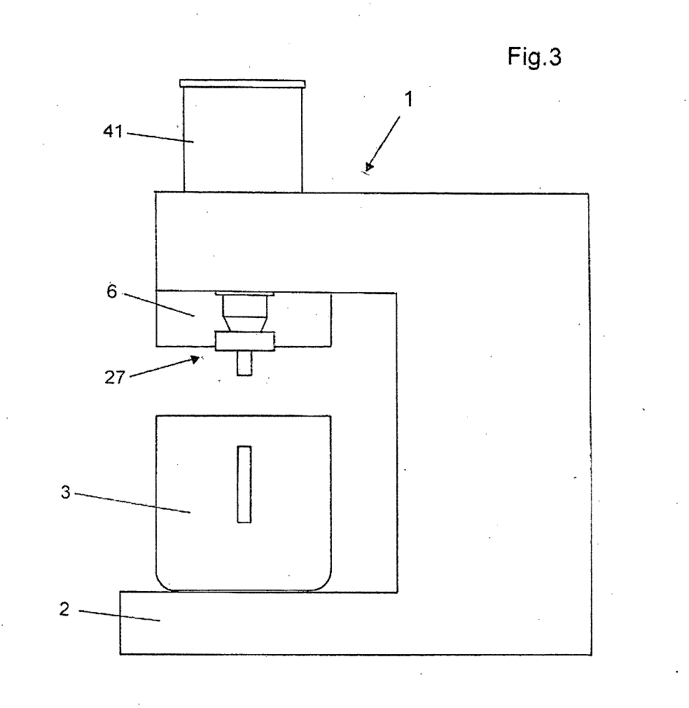

FIG. 3 is the side view of the device for preparing beverages of FIG. 1.

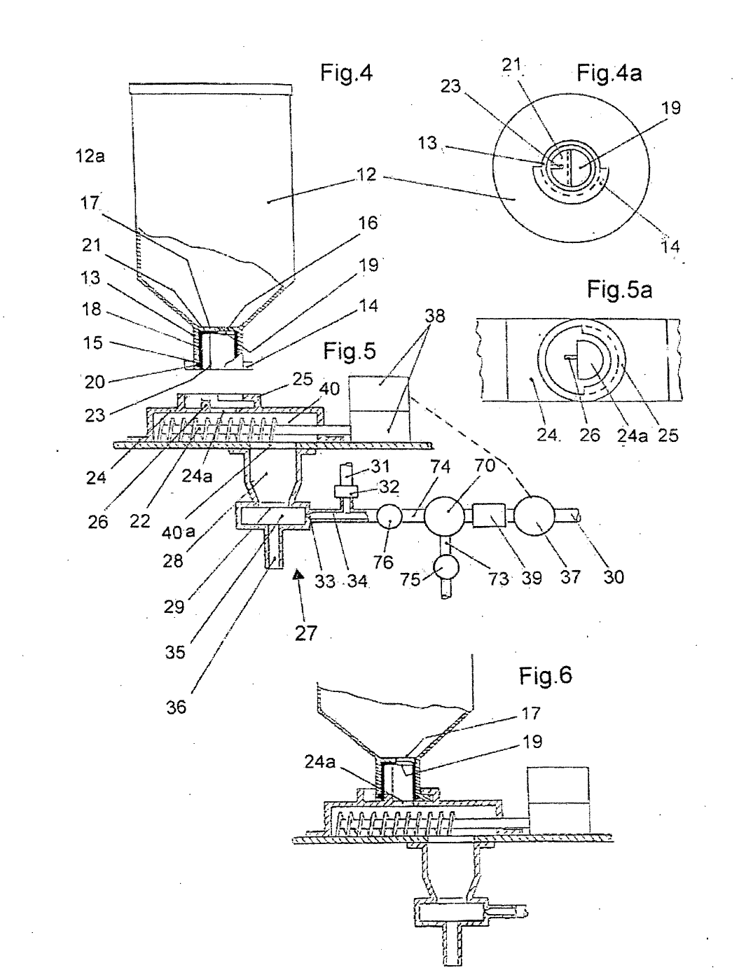

FIG. 4 is a cylindrical multi-portion container, partly in cross section, comprising a funnel-like rejuvenating lower section passing over into a cylindrical neck, a partly open bottom provided inside at the neck projection,

a rotary locking cylinder engaged in a groove provided in the neck and having a partly open upper side, wherein the closed portion of its upper side covers the partly open bottom of the multi-portion container bottom, a stop bar arranged on the locking cylinder and provided as a rotation protection for the locking cylinder, and a bayonet catch element disposed at the periphery of the neck.

FIG. 4a is the bottom view of the multi-portion container of FIG. 4.

FIG. 5 is a cross section through the bayonet docking device belonging to FIG. 5 for the multi-portion container including the milk powder worm conveyor and the worm conveyor, and a mixing and frothing device.

FIG. 5a is the top view onto the bayonet docking device of FIG. 5.

FIG. 6 is, partly in cross section, the multi-portion container of FIG. 4 docked to, and locked, to the docking device of the brewing unit, showing the multi-portion container with its bottom opening turned to “passage”

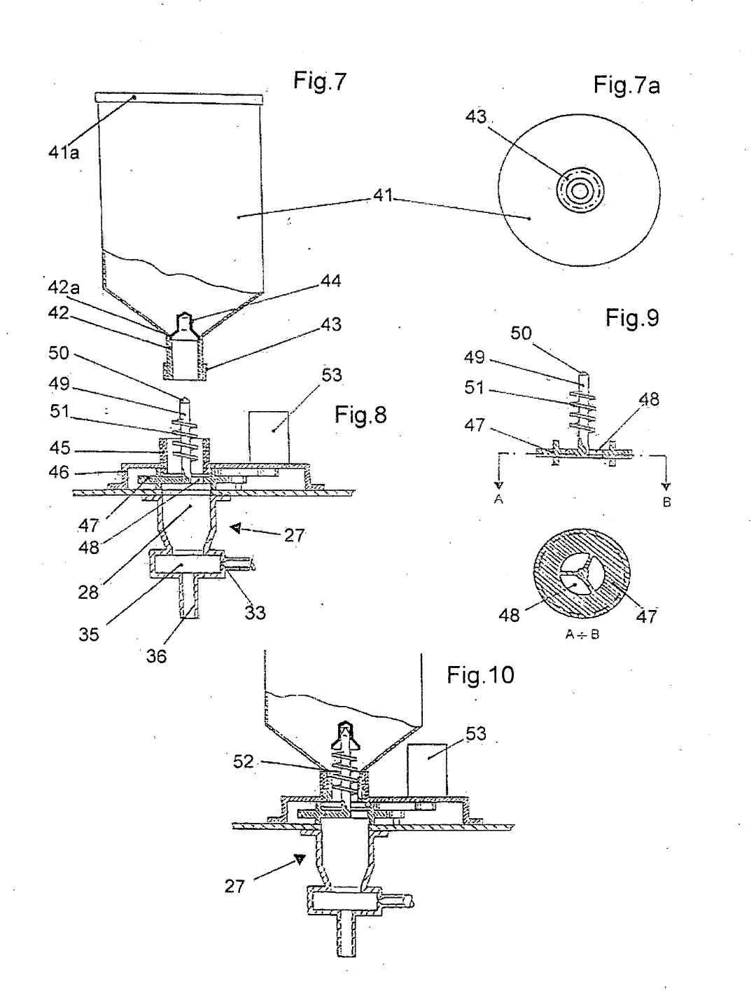

FIG. 7 is, partly in cross section, a cylindrical multi-portion container having a hat-shaped locking cap pressed into the inner side of the neck and a thread provided on the outside of the neck.

FIG. 7a is the bottom view of the multi-portion milk powder container of FIG. 7.

FIG. 8 is a cross section through the thread docking device of FIG. 7 for the multi-portion container including a vertical shaft for the multi-portion container locking cap and a worm conveyer combined with a shaft for the milk powder, and a mixing and frothing device.

FIG. 9 is, partly in cross section, the shaft and the worm conveyor of FIG. 8 as a detail.

FIG. 10 is, partly in cross section, the docking device of FIG. 8 including the docked-on multi-portion container of FIG. 7 together with the vertically disposed shaft, the worm conveyor, the ejected locking cap and the mixing and frothing device.

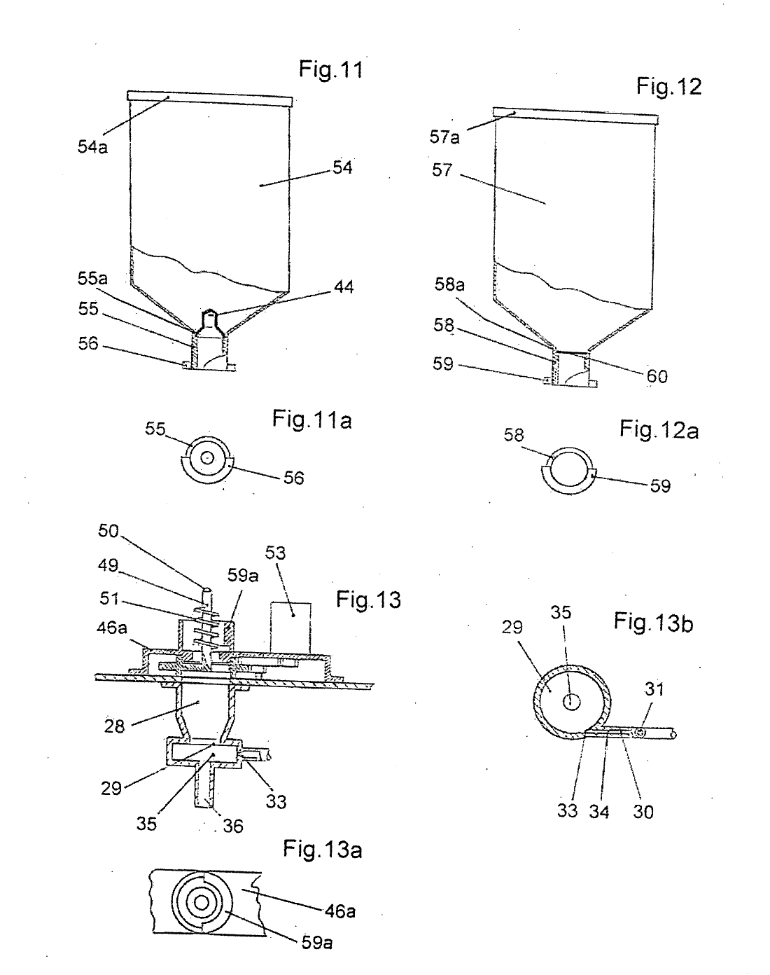

FIG. 11 is, partly in cross section, a cylindrical multi-portion container having a locking cap pressed into the inner side of the neck and a bayonet catch element disposed on the neck.

FIG. 11a is the bottom view of the multi-portion container of FIG. 11.

FIG. 12 is, partly in cross section, a cylindrical multi-portion container having a locking foil disposed, inside, at the projection of the neck and a bayonet catch element disposed on the neck.

FIG. 12a is the bottom view of the multi-portion container of FIG. 12.

FIG. 13 is a cross section through the bayonet docking device of FIGS. 11 and 12 for the multi-portion container and the ejection shaft for the locking cap of the multi-portion container of FIG. 11 or for the locking foil of the multi-portion container of FIG. 12 and the mixing and frothing device.

FIG. 13a is the top view on the bayonet docking device of FIG. 13.

FIG. 13b is a cross section through the frothing chamber of the mixing and frothing device at the level of the nozzle entry of the water supply.

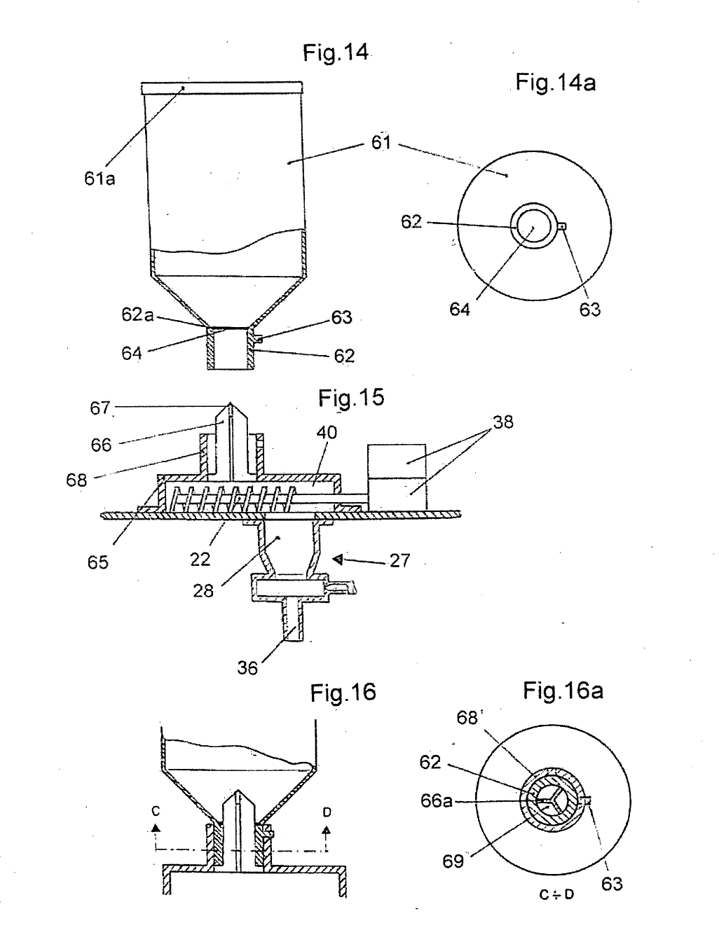

FIG. 14 is, partly in cross section, a cylindrical multi-portion container including a locking foil disposed inside in front of the neck and a bayonet catch element disposed on the neck.

FIG. 14a is the bottom view of the multi-portion container of FIG. 14.

FIG. 15 is a cross section through the bayonet docking device belonging to the multi-portion container of FIG. 14 including a piercing needle for the locking foil, the milk powder conveyor device and the mixing and frothing device.

FIG. 16 is, partly in cross section, the docking device of FIG. 15 together with the docked multi-portion container of FIG. 14 showing the pierced locking foil and the mixing and frothing device.

FIG. 16a is a cross section through the docking device of FIG. 16 including the docked-on multi-portion container.

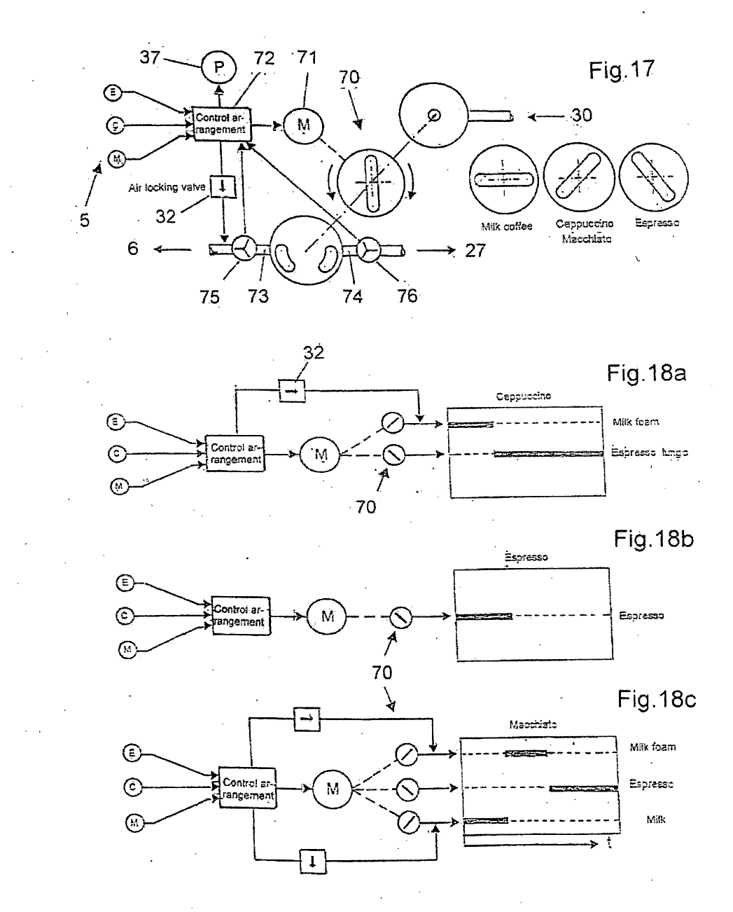

FIG. 17 shows, diagrammatically in a disassembled representation, a two-way ceramics disc valve for the hot water supply to the coffee brewing chamber and/or the mixing and frothing device.

FIG. 18a shows diagrammatically the position of the ceramics disc valve and of an air locking valve for the preparation of cappuccino, and a respective flow chart.

FIG. 18b shows diagrammatically the position of the ceramics disc valve and of an air locking valve for the preparation of espresso, and a respective flow chart.

FIG. 18c shows diagrammatically the position of the ceramics disc valve and of an air locking valve for the preparation of latte macchiato, and a respective flow chart.

FIG. 1 shows a device for preparing beverages 1 comprising a base 2, a receiving vessel 3, and a coffee brewing chamber 6 and a multi-portion container 41 including an ejected locking cap 44 docked in docking device 7. Below the docking device 7, a mixing and frothing device 27 is disposed. In the docking device, a presence checking means 8 is provided. To switch the preparation device on, a mains switch 4 and to select a beverage, a group of program selection buttons 5 are provided.

FIG. 2 shows a device for preparing beverages 1 comprising a base 2, a receiving vessel 3 and a coffee brewing chamber 6 in the shape of a receiving device 9 for a coffee portion capsule with a coffee portion capsule 10 inserted, a water supply needle 11a pierced into the coffee portion capsule, a presence checking means 11a and an upper part in the closed state, and a multi-portion container 41 docked in docking device 7 with the locking cap 44 ejected. Below the docking device 7, a mixing and frothing device 27 is disposed.

To switch the preparation device on, a mains switch 4 and to select a beverage, a group of program selection buttons 5 is provided.

In FIG. 3, the preparation device 1 is shown as a side view including a base 2, a receiving vessel 3, a coffee brewing chamber 6, a docked multi-portion milk powder container 41 and a frothing device 27.

In the embodiment shown in FIGS. 4 and 4a of a multi-portion milk powder container 12, the locking cylinder engaged with its engaging bulge 20 in the engaging groove 15 of the neck 13 of the multi-portion milk powder container 12 locks, with the locked section 21 of its upper side, the partial opening 17 of the multi-portion milk powder container bottom 16 so that the multi-portion milk powder container 12 is tightly closed. The neck 13 of the multi-portion milk powder container 12 is provided with a bayonet catch element 14 for docking at the device for preparing beverages. The device for preparing beverages is provided with a bayonet catch 25 to permit docking of the multi-portion milk powder container. The locking cylinder 18 is provided with a stop bar 23 which in combination with a holdback square 26 of the docking device 24 of the preparation device avoids a turn of the locking cylinder 18 during the docking process. Below the docking device 24, a conveying track 40 is provided which conveys by means of a worm conveyor 22 driven by a motor gear unit 38, the milk powder to a mixing and frothing device generally designated by 27. The conveying track 40 is provided with an aperture 40a through which the milk powder flows into the inlet of the mixing and frothing device. The mixing and frothing unit 27 comprises essentially an inflow funnel 28, below the inflow funnel a frothing chamber 35 and below the latter an outflow track 36. These portions of the frothing device, as shown in the drawing, are concentrically arranged one above the other to form a virtual axle center and are essentially rotation symmetrically shaped. An upper cover wall of the frothing chamber 35 is broken through in the middle by a powder inlet opening 29 and passes via the latter into the inflow funnel 28 above it. The diameter of the circular powder inlet opening is smaller than the internal diameter of the frothing chamber. Starting from the powder inlet opening 29, the interior of the inflow funnel 28 expands progressively upward.

Into the frothing chamber 35 opens a nozzle 33 which is disposed in the cylindrical wall of the frothing chamber 35 so that the nozzle ends open tangentially to an inner wall of the frothing chamber. The nozzle is disposed at about half the height of the cylindrical wall of the frothing chamber 35.

For frothing but also just for the preparation of a beverage from dissolved milk powder, a water pipe 30 is connected upstream via a continuous flow heater 39 and a pump 37 with a water source not shown. Downstream, it provides via a ceramics disc valve 70, the ceramics valve outlet 74 and a flow meter 76 the water inlet 34 for the nozzle 33 with hot water. Near the water inflow 34 into nozzle, an air track 31 which is in connected via a locking valve 32 with outer the atmosphere, opens into the water inflow pipe 34. The locking valve 32 is opened for froth generation. In order to coordinate the conveying amount of the powder by worm conveyor 22 with the water amount pumped by means of water pump 37, a drive of water pump 37 (not shown) is connected with the worm conveyor drive 38 via a coupling which is indicated in FIG. 4 by a broken line and which can be realized by a connecting gear or a common control arrangement of the drives in order to assure an optimal amount ratio of the milk powder to the hot water flow. The neck 42 of the embodiment shown in FIGS. 7 and 7a of a multi-portion milk powder container 41 is closed at the inner neck projection 42a with a hat-shaped locking cap 44. The hat-shaped cap 44 is pressed into the neck projection. At the external periphery of the neck 42, a thread 43 is formed out. The docking device 46 shown in FIG. 8 and belonging to this embodiment of a multi-portion milk powder container 41 is equipped with a threaded sleeve 45 which is provided with an internal thread. In the docking device 46, a vertical ejection shaft 49 with a worm conveyor 51 is disposed. The worm conveyor 51 is provided with a drive gear 47 driven by a motor gear unit 53. The worm conveyor coils about a centrally disposed shaft 49, the tip 50 of which is suited to push during the course of the docking process the locking cap 44 from its seat in the neck projection of the multi-portion milk powder container 41, as shown in FIG. 10, to the interior. The drive gear 47 of the worm conveyor is provided with apertures 48 for the passage of the milk powder. The mixing and frothing device 27 provided below the docking device 46 corresponds to that described in FIG. 5.

The embodiment of a multi-portion milk powder container 54 shown in FIGS. 11 and 11a and the respective docking device 46a differ from the embodiment 41 shown in FIGS. 7 and 7a only by bayonet catch devices 56 on the multi-portion milk powder container 54 and the bayonet catch 59a on the docking device 46a.

In the case of the embodiment of a multi-portion milk powder container 57 shown in FIGS. 12 and 12a, the latter is closed at its inner neck projection 57a by a locking foil 60. In the respective docking device 46a, a vertical worm conveyor 51 is disposed as well, as shown in FIGS. 1 and 3, which is provided with a drive gear 47 driven by a motor gear unit 53. The worm conveyor coils about a centrally disposed ejection shaft 49 the tip 50 of which is suited to pierce during the course of the docking process through the locking foil 60 in the neck projection 57a of the multi-portion milk powder container. The gear wheel 47 of the worm conveyor 51 is provided with apertures 48 for the passage of the milk powder. The docking elements 59 and 59a are shaped in the form of a bayonet catch.

The multi-portion milk powder container 61 is closed, at its internal neck projection 62a by a locking foil 64. The docking device 65 is provided with a piercing needle 66 which is suited to pierce through the locking foil during the course of the docking process. The piercing needle 66 is formed of at least three bars 66a radially extending from a vertical center axis and tapering at its upper end in a common tip 67. The multi-portion milk powder unit 61 and the docking device 65 are provided with bayonet catch devices 63 and 68.

All multi-portion milk powder units and the respective docking devices are preferably provided with a bayonet or threading docking devices. It is also conceivable to produce the docking devices in the form of a spring catch or other docking structures.

In FIG. 17, the two-way ceramics disc valve 70 which is connected to the hot water supply pipe 30 is shown by three ceramics discs displayed in a disassembled form. Of these three discs, one outer disc shows an outlet 73 which feeds, via a flow meter 75, the brewing water supply to the coffee or cocoa brewing chamber 6 with brewing water, and a further outlet 74 which is connected, via a flow meter 76, with the hot water supply pipe 34 to the mixing and frothing device 27. Depending on the position of the middle disc of the ceramics valve 70, either the outlet 73 or the outlet 74, or both outlets simultaneously, may used for the preparation of coffee or milk froth.

In the position of the middle disc of the ceramics valve shown on the left part of FIG. 4, it is in its zero position. In order to prepare a beverage, the disc may be turned, either by hand or program-controlled by means of a motor 71, successively into the position “espresso” or “milk/milk froth”, “latte macchiato” or “milk coffee”, depending on the kind of beverage desired. These possible positions are shown for the middle disc in the right part of FIG. 4. After the preparation cycle, the disc is returned into its zero position, either automatically or manually, or suitably coupled with the opening process of the brewing chamber.

In the FIGS. 18a, 18b, 18c, the respective position of the ceramics valve 70 and of the air locking valve 32, and the respective preparation flow chart for the preparation of cappuccino, espresso or latte macchiato is shown.

For the preparation of a coffee or coffee/milk beverage, the following possibilities are available:

In order to prepare a coffee, the brewing chamber 6 is filled with either loose coffee powder or a proportioned coffee portion unit 10. The filling of the brewing chamber 6 with either loose coffee powder or with a coffee or cocoa portion unit 10 differ among each other depending on the structural form and the embodiment of the device for preparing beverages; they constitute the state of the art and need no longer be described in detail.

After filling the brewing chamber 6 with coffee or a coffee portion unit 10 and switching the preparation device on by means of a mains switch 4, the coffee/espresso preparation is called up by means of the group of program selection buttons 5 or of a program selection switch, and is switched in such a way that the brewing water is supplied to the coffee brewing chamber 6 only. During the course of the brewing process, the coffee liquid will then flow via the outlet track into the receiving vessel 3.

For the preparation of a milk beverage and depending on the structural shape, the multi-portion milk powder container is docked, by means of its docking device to the respective docking device of the device for preparing a beverage in that its neck including the locking elements is inserted into the docking device and is tightly locked, by means of its bayonet catch element and the corresponding bayonet catch of the docking device, by a turning movement or by screwing its threading locking elements into the female thread of the docking device. In this case it can be checked by a checking means which is for instance realized by a micro switch 8 and a control arrangement 72 whether or not a multi-portion milk powder container is in the docking device.

After switching the preparation device on by means of mains switch 4, the kind of beverage is called up by means of a group of program selection buttons 5 or a program selection switch and, by means of the control arrangement 72, the valve arrangement 70 is switched so that the hot water is supplied either to the coffee brewing chamber 6 only or to the mixing and frothing device 27 only or to both devices.

After switching the preparation device on by means of mains switch 4, the kind of beverage is called up by means of the group of program selection buttons 5 or a program selection switch and, by means of a control arrangement 72 the valve arrangement 70 is switched so that the hot water is supplied either to the coffee brewing chamber 6 only or to the mixing and frothing device 27 only or to both devices.

In a first embodiment of a multi-portion container, the multi-portion container 12, as shown in FIG. 6, is closed by means of a locking cylinder 18 in its neck. The locking cylinder 18 is pivotally engaged by means of an engaging bulge 20 in an engaging groove 15 of the neck and covers in the rest position, with the closed half 21 of its upper side, the opening 17 of the milk powder container bottom 16 so that the multi-portion container 12 is tightly closed. For docking the multi-portion container 12 to the docking device 24, it is inserted with its neck 13 which is provided with a bayonet catch element 14 into the bayonet catch 25 of the docking unit 24 and manually turned about 180 degrees up to the stop. In this way, the multi-portion container 12 is solidly locked by means of bayonet catch element 14 and bayonet catch 25 of the docking unit. During the turning, the stop bar 23 of the locking cylinder 18 is held back by the hold back square 26 of the bayonet docking device 25 and in this way, a rotation of the locking cylinder is avoided. By this, the passage openings 17 of the multi-portion container bottom 16 and the passage opening 19 of the locking cylinder 18 are in coincidence and the milk powder flows through the aperture 24a of docking device 24 into the conveying track 40 and is conveyed by worm conveyor 22 to the mixing and frothing unit 27 during the course of which passage it falls through the aperture 40a into the inflow funnel 28 of the mixing and frothing device 27. For the preparation of milk froth, the motor gear unit 38 of the worm conveyor 22 and the water pump 37 for conveying the preparation water are synchronously switched on. The conveyor spindle 22 conveys the milk powder into the inflow funnel 28 of the mixing and frothing unit 27. At the same time, the water pump 37 pumps fresh water from a water container, not shown, via a water supply pipe 30 through a continuous flow heater 39 and a ceramics disc valve 70 into the frothing chamber 35 of the mixing and frothing unit 27. The conveyed quantities of milk powder and water are programmed tuned to one another. The frothing chamber 35 is disposed below the inflow funnel 28 and is cylindrically constructed. Through the inflow tunnel 28, it is connected to an upper inlet opening 29 the diameter of which is smaller than the diameter of the frothing chamber 35. In the downward direction, the frothing chamber is connected with an outflow track 36. The water inflow into the frothing chamber 35 occurs tangentially through a nozzle 33 in about half the height of the cylindrical frothing chamber 35. Shortly before the inflow of the hot water jet into the frothing chamber, an air pipe 31 opens into the hot water supply pipe 20 so that the water flowing with high speed through the water inflow pipe 34 will drag the air along. By the tangential inflow, the water-air mixture is brought into a rapid rotation in the cylindrical frothing chamber 35 and exits partly from the frothing camber 35 upward into the inflow funnel 28 and, caused by the enlarging shape of the inflow funnel 28, mounts up in it and mixes there with the inflowing milk powder. In the course of this, the resulting milk-air mixture loses rotation energy and drops, within the upwardly mounting water vortex, back into the frothing chamber 35 where it is brought again into more rapid rotation by the newly inflowing water, and is frothing up. Since water and milk powder continue to flow in, a continuous mixing and frothing process comes up, wherein the resulting milk froth is pushed downwardly out of the frothing chamber and flows off via the outflow track 36. The air pipe 31 is provided with an air valve 32 which permits to interrupt the air supply to the water pipe 30. This makes possible to prepare solely hot milk instead of milk froth. During the course of the milk froth generation, the locking valve 32 disposed in the air pipe 31 is open. If, on the other hand, the locking valve 32 is closed which can be effected either manually or, program-controlled, automatically and the air supply to the frothing cylinder 35 consequently is blocked, froth generation in it is substantially precluded, and from the outflow track of the frothing cylinder only hot milk will flow out.

It is, therefore, possible to generate, program-controlled, in one operational sequence, milk-milk froth-espresso for the preparation of latte macchiato. In order to remove the multi-portion milk powder container 12, it is turned back about 180 degrees and in this way the bayonet receiving device is unlocked.

In a second embodiment of the multi-portion milk powder container, the neck 42 of the multi-portion milk powder container 41 is provided with an outside screw thread 43. Into the neck 42 of the multi-portion milk powder container 41, a hat-shaped locking cap 44 is pressed in. When filling the coffee preparation device, the neck 42 of the multi-portion milk powder container 41 is inserted into the threaded sleeve 45 of the docking device 46 and screwed on to the stop. At the same time, the tip 50 of the ejection shaft 49 of the worm conveyor 51 moves into the locking cap 44 and ejects it from its locking position. Through the resulting annular chute aperture 52, the milk powder flows into the worm conveyor 51. For the preparation of milk froth, both the motor gear unit 53 of the worm conveyor 51 and the water pipe 37 which is programmed for the transportation of hot water and milk powder in a tuned amount ratio, are synchronously switched on. The motor gear unit 53 drives in this case the worm conveyor gear wheel 47 which constitutes one structural unit together with the worm conveyor 51, and the milk powder is conveyed by the worm conveyor 51 through the worm conveyor gear wheel apertures 48 vertically into the inflow funnel 28 of the mixing and frothing device 27. Water supply and frothing process are identical to the first embodiment. The resulting milk froth flows also via the outflow track 36 into the receiving vessel. For removing, the multi-portion milk powder container is screwed out of the threaded sleeve 45.

In a further version of a multi-portion milk powder container of this embodiment of the locking cap 44, coupling and locking of the milk powder container 54 is not effected by means of a thread but rather by a bayonet catch 56.

In a third embodiment of a multi-portion milk powder container, the locking cap of the multi-portion milk powder container 57 is realized by a locking foil 60 disposed at the internal neck projection 58a. Docking of the multi-portion milk powder container 57 at the docking device 46a and locking is realized by the bayonet catch element 59 disposed on the neck 58 of the multi-portion milk powder container 57 and bayonet catch sleeve 59a on the docking device 46a. During the course of the docking process, the tip 50 of the ejection shaft 49 of the worm conveyor 51 pierces through the locking foil 60 and, through the aperture 52 obtained, the milk powder flows into the worm conveyor 51, and the latter transports the milk powder vertically directly into the inflow funnel 28 of the mixing and frothing device 27. The mixing and frothing process is identical to the first embodiment. The milk froth generated flows also via the outflow track 36 into the receiving vessel.

In a fourth embodiment of a multi-portion milk powder container 61, the latter is also closed at its internal neck projection 62a by a locking foil 64. Docking and locking of the multi-portion milk powder container 61 is also done by means of a bayonet catch element 63 on the neck 62 of the multi-portion milk powder container 61 and a bayonet catch 68. During the course of the docking process, the piercing needle 66 disposed on the docking device 65 pierces, with the tip of its radially disposed vertical bars 66a, through the locking foil 64, and the milk powder flows through the free spaces 69 between the bars 66a into the conveying track 40 and is transported by the worm conveyor 22 into the inflow funnel 28 of the mixing and frothing device 27.

The mixing and frothing process is identical to the first embodiment. The milk froth generated flows also via the outflow track 36 into the receiving vessel.

For the preparation of a coffee-milk beverage, the coffee brewing chamber 6 is filled with coffee, and a multi-portion milk powder container is docked at the docking device.

The preparation of the coffee milk beverage is realized either manually or, program-controlled, successively, as shown in FIGS. 18a and 18, in the following sequence:

For cappuccino: First: preparation of the milk froth, then preparation of coffee.
For latte macchiato: First: preparation of milk, then milk froth, then espresso.

### REFERENCE NUMERALS

1 Device for preparing beverages
2 Base of the device
3 Receiving vessel
4 Mains switch
5 Group of program selection buttons
6 Coffee brewing chamber
6a Coffee outlet
7 Docking device
8 Checking means
9 Coffee capsule receiving device
9a Coffee outlet
10 Coffee capsule
11 Receiving device upper part
11a Checking means
12 Multi-portion milk powder container
12a Multi-portion milk powder container lid
13 Multi-portion milk powder container neck
14 Bayonet catch element
15 Engaging bulge
16 Multi-portion milk powder container bottom, locked portion
17 Multi-portion milk powder container bottom, open portion
18 Locking cylinder
19 Locking cylinder, open portion
20 Engaging groove
21 Locking cylinder lid, locked portion
22 Worm conveyor
23 Stop bar
24 Docking device
25 Bayonet catch
26 Hold-back square
27 Mixing and frothing device
28 Inflow tunnel
29 Upper inlet opening
30 Hot water pipe
31 Air pipe
32 Locking valve
33 Nozzle
34 Hot water inflow pipe
35 Frothing chamber
36 Outflow track
37 Water pump
38 Motor gear unit
39 Continuous flow heater
40 Conveying track
40a Aperture
41 Multi-portion milk powder container
41a Multi-portion milk powder container lid
42 Multi-portion milk powder container neck
42a Internal neck projection
43 Docking thread
44 Locking cap
45 Threaded sleeve
46 Docking device
47 Drive gear
48 Gear wheel apertures
49 Ejection shaft
50 Worm conveyor shaft tip
51 Worm conveyor
52 Chute aperture
53 Motor gear unit
54 Multi-portion milk powder container
54a Multi-portion milk powder container lid
55 Multi-portion milk powder container neck
55a Internal neck projection
56 Bayonet catch element
57 Multi-portion milk powder container
57a Multi-portion milk powder container lid
58 Multi-portion milk powder container neck
58a Internal neck projection
59 Bayonet catch element
60 Locking foil
61 Multi-portion milk powder container
61a Multi-portion milk powder container lid
62 Multi-portion milk powder container neck
62a Internal neck projection
63 Bayonet catch element
64 Locking foil
65 Docking device
66 Piercing needle
66a Piercing needle bars
67 Piercing needle tip
68 Bayonet catch sleeve
70 Ceramics disc valve
71 Motor
72 Control arrangement
73 Ceramics disc valve outlet
74 Ceramics disc valve outlet
75 Flow meter
76 Flow meter

1. Brewing unit of a device for preparing beverages comprising a first receiving device which is a coffee brewing chamber (6, 9) having an outlet, suitable for receiving loose coffee powder or a coffee or cocoa portion unit (10) and suitable for the preparation of a beverage by using said unit,
wherein said brewing unit is equipped with a second receiving device which together with a docking device (7, 24, 46, 46a, 65) is suited for receiving a removable multi-portion container (12, 41, 54, 57, 61) for milk powder,
wherein said brewing unit is provided with a mixing and frothing device (27) having an outflow (36) connected in flow connection with said docking device (7, 24, 46, 46a, 65) of said second receiving device and suited for the preparation of a milk produce, particularly milk froth,
wherein both the coffee brewing chamber and the docketing device constitute a compact common structural unit, and
wherein said docking device (7, 24, 46, 46a, 65) is provided with opening elements (26, 50, 66) which are suited to open the locking elements (18, 44, 60) of a multi-portion container (12, 41, 54, 57, 61) during the course of the docking process.

2. (canceled)

3. (canceled)

4. Brewing unit according to claim 1,
characterized in
that said brewing unit is provided with a conveying track (40) which connects said docking device (7, 24, 46, 46a, 65) with said mixing and frothing device (27) and through which the milk powder is conveyed from the docking device into the mixing and frothing device.

5. Brewing unit according to claim 1,
characterized in
that said mixing and frothing device (27) is removable.

6. Brewing unit according to claim 3,
characterized in
that said mixing and frothing device (27) is made as a throw-away part.

7. Brewing unit according to claim 1,
characterized in
that the outlet (6a; 9a) of said coffee brewing chamber (6, 9) and the outlet of the mixing and frothing device are joined together to form one common outlet.

8. Brewing unit according to claim 1,
characterized in
that the upper part (11) of the coffee brewing chamber (9) is provided with sealing elements and locking elements for a pressure and fluid tight closure of said first receiving device.

9. Brewing unit according to claim 1,
characterized in
that an automatic ejector device for the portion unit is associated to said coffee brewing chamber (9).

10. Brewing unit according to claim 1,
characterized in
that on said coffee brewing chamber (9) and on said mixing and frothing device (27) a rinsing device is provided which can be activated for both devices simultaneously.

11. Brewing unit according to claim 1,
characterized in
that one water supply pipe opens each in the coffee brewing chamber (6, 9) and in the mixing and frothing device (27),
that the water supply can be activated by a control arrangement (72) which is so designed that water is supplied essentially simultaneously to either said coffee brewing chamber (6, 9) and to the mixing and frothing device (27) or only to said coffee brewing chamber or only to the mixing and frothing device.

12. Brewing unit according to claim 9,
characterized in
that said control arrangement (72) comprises a controlled valve arrangement (70) via which the water supply to the coffee brewing chamber and to the mixing and frothing device is realized.

13. Brewing unit according to claim 10,
characterized by
a ceramics disc valve (70) as a controlled valve.

14. Brewing unit according to claim 10,
characterized by
solenoid valves as controlled valves.

15. Brewing unit according to claim 10,
characterized by
hose clip valves as controlled valves.

16. Brewing unit according to claim 9,
characterized in
that on said second receiving device a checking means (8) is arranged which is connected with said control arrangement (72), and
that said checking means and said control arrangement are so designed that water supply to said mixing and frothing device (27) is permitted only if and when a multi-portion container is docked.

17. Brewing unit according to claim 9,
characterized in
that in said coffee brewing chamber (9) a checking unit (11a) is arranged which is connected with said control arrangement (72), and
that said checking unit and said control arrangement are so designed that water supply to said coffee brewing chamber is permitted only if and when a portion unit (10) is in said coffee brewing chamber.

18. Brewing unit according to claim 6,
characterized in
that on said coffee brewing chamber (9) checking means are provided which interrupt the preparation water supply if and when the coffee brewing chamber is not closed or is being opened during the course of the preparation process.

19. Brewing unit according to claim 9,
characterized in
that said control arrangement (72) is suited to control, by means of a valve arrangement (70) and flow meters (75, 76), a fixed-programmed sequence and amount of the water supply to said coffee brewing chamber (6, 9) and to said mixing and frothing device (27) so that a coffee-milk beverage can automatically be prepared.

20. Brewing unit according to claim 9,
characterized in
that in said control arrangement (72), a plurality of programs is stored for the sequence and the amount of the water supply to said coffee brewing chamber (6, 9) and to the mixing and frothing device (27), and that in said control arrangement a selection device is provided by which one of the stored programs can be selected.

21. Brewing unit according to claim 9,
characterized in
that the control of the preparation sequence and of the respective amount of the individual beverage components may manually be performed with the aid of control means.

22. Brewing unit according to claim 1,
characterized in
that said brewing unit is provided with a steam generator and a steam nozzle.
